(19) United States
(12) Patent Application Publication
(10) Pub. No.: US 2015/0085505 A1
(43) Pub. Date: Mar. 26, 2015

(54) LAMP POLE AND LED LAMP

(71) Applicant: HON HAI PRECISION INDUSTRY CO., LTD., New Taipei (TW)

(72) Inventor: SHIEN-CHENG KUO, New Taipei (TW)

(73) Assignee: HON HAI PRECISION INDUSTRY CO., LTD., New Taipei (TW)

(21) Appl. No.: 14/267,038

(22) Filed: May 1, 2014

(30) Foreign Application Priority Data
Sep. 26, 2013 (CN) 2013104425307

(51) Int. Cl. F21V 21/14

(52) U.S. Cl. CPC F21V 21/14
USPC 362/421

(57) ABSTRACT

A lamp pole for supporting a lamp head includes a number of movable members connected in sequence. Each movable member includes a first connecting portion and a second connecting portion. The first connecting portion and the second connecting portion are both bowl-shaped. The first connecting portion of the movable member is connected to the second connecting portion of an adjacent movable member, such that the first connecting portion is rotatably received in the second connecting portion. An LED lamp including the lamp pole is also disclosed.

### FIELD

The present disclosure relates to a lamp pole and a light emitting diode (LED) lamp.

### BACKGROUND

An LED lamp usually includes a lamp head, a base, and a lamp pole. The lamp pole connects the lamp head to the base. The lamp pole is usually hollow and made of aluminum.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is a perspective view of an embodiment of an LED lamp.

FIG. 2 is an exploded view of part of the LED lamp of FIG. 1.

FIG. 3 is a cross-sectional view taken along line III-III of FIG. 2.

FIG. 4 is a cross-sectional view taken along line IV-IV FIG. 2.

### DETAILED DESCRIPTION

This disclosure is illustrated by way of example and not by way of limitation in the figures of the accompanying drawings in which like reference numbers indicate similar elements. It should be noted that references to “an” or “one” embodiment in this disclosure are not necessarily to the same embodiment, and such references mean “at least one.”

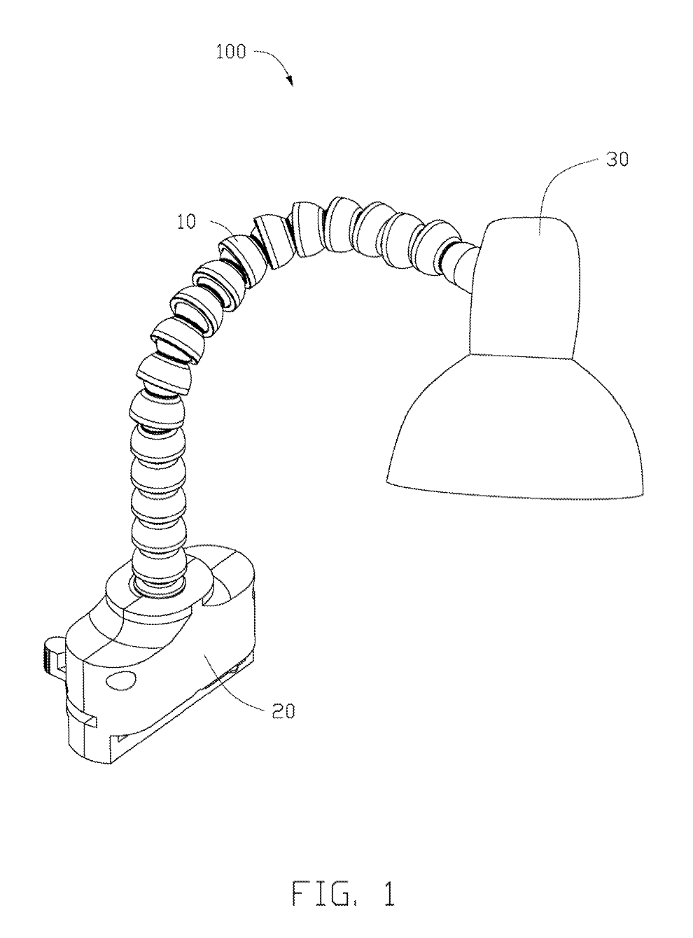

FIG. 1 illustrates an embodiment of an LED lamp 100. The LED lamp 100 can include a lamp pole 10, a base 20, and a lamp head 30. A first end portion of the lamp pole 10 can be mounted to the base 20, and a second end portion of the lamp pole 10 can be connected to the lamp head 30. The lamp pole 10 can be configured for supporting the lamp head 30. The lamp head 30 can include a plurality of LED lights.

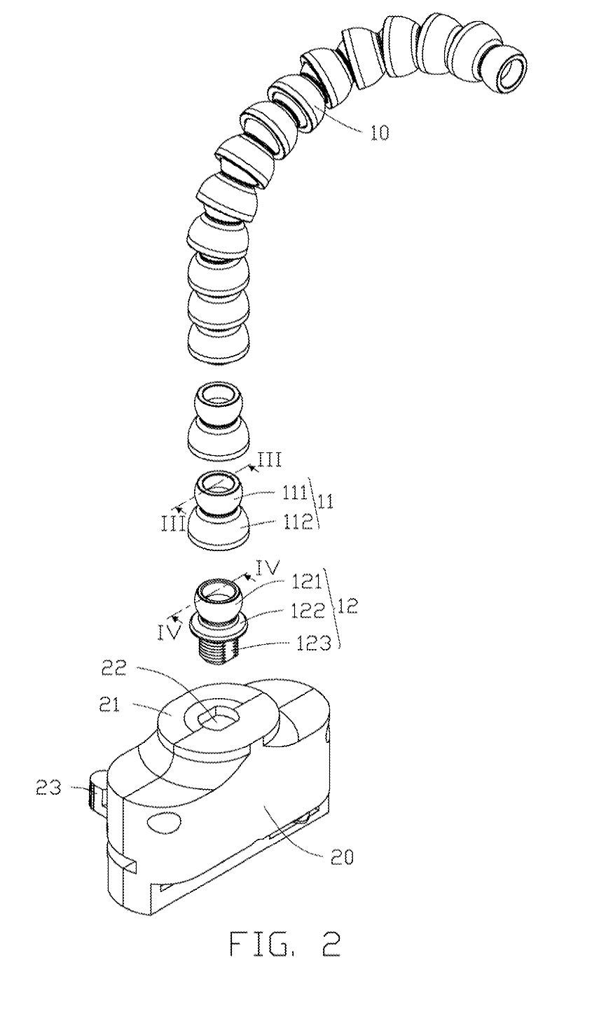

FIG. 2 illustrates that the lamp pole 10 includes a number of movable members 11 connected in sequence and a plug 12 configured for connecting the pole 10 to the base 20. In one embodiment, the lamp pole 10 can be made of plastic, thereby reducing a weight of the LED lamp 100.

Each of the movable members 11 can include a first connecting portion 111 and a second connecting portion 112 connected to the first connecting portion 111. The first connecting portion 111 and the second connecting portion 112 can be substantially bowl-shaped. A maximum diameter of the first connecting portion 111 can be smaller than a maximum diameter of the second connecting portion 112.

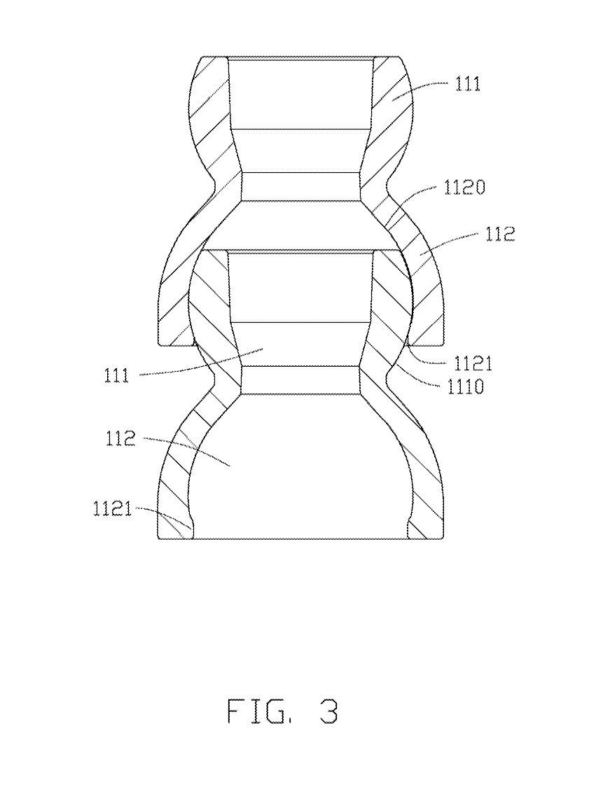

FIG. 3 illustrates that the first connecting portion 111 of each movable member 11 can be connected to the second connecting portion 112 of an adjacent movable member 11 by being received in the adjacent second connecting portion 112. The first connecting portion 111 can include an outer surface 1110, and the second connecting portion 112 includes an inner surface 1120. The outer surface 1110 of the movable member 11 can be in tight contact with the inner surface 1120 of the connecting portion 112 of the adjacent movable member 11.

A distal end portion of the second connecting portion 112 can include a flange 1121 on the inner surface 1120. The maximum diameter of the first connecting portion 111 can be slightly larger than the maximum diameter of the inner space of the second connecting portion 112 bound by the flange 1121. Thus, as the first connecting portion 111 is received in the second connecting portion 112 of the adjacent movable member 11, the flange 1121 of the second connecting portion 112 can lock the first connecting portion 111.

As the movable members 11 are connected one-by-one and locked together by the flanges 1121 of the second connecting portions 112, the movable members 11 are prevented from separating from each other. Because the first connecting portion 111 and the second connecting portion 112 can be bowl-shaped, the first connecting portion 111 can rotate in the second connecting portion 112 of the adjacent movable member 11 as a ball-and-socket joint. Therefore, each movable member 11 can be adjusted individually, and a height, bending angle, and bending direction of the lamp pole 10 can be adjusted freely. Furthermore, an illumination range of the LED lamp 100 can be easily adjusted.

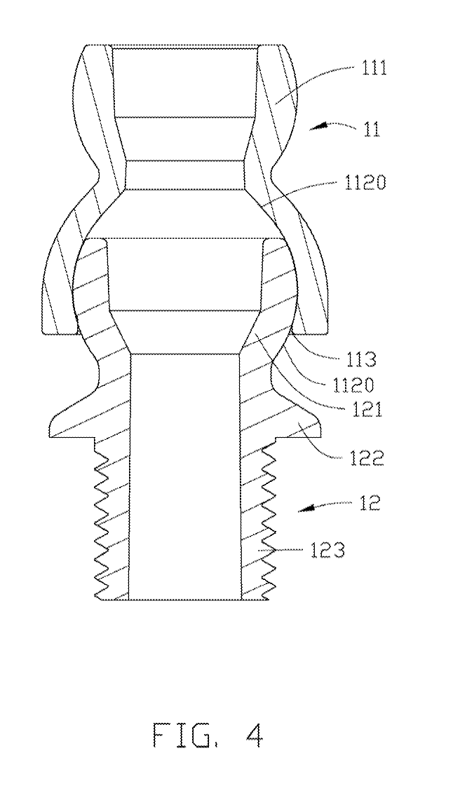

FIG. 4 illustrates the plug 12 connected to a terminal movable member 11 at one end of the lamp pole 10. Referring to FIG. 2 and FIG. 4, the plug 12 can include a third connecting portion 121, a shoulder 122, and a cylinder portion 123. The third connecting portion 121 can be bowl-shaped, and a size and shape of the third connecting portion 121 can be substantially same as a size and shape of the first connecting portion 111. A maximum diameter of the third connecting portion 121 can be slightly smaller than the inner space of the second connecting portion 112 bound by the flange 1121. The third connecting portion 121 can be rotatably received in the second connecting portion 112 of the terminal movable member 11. The third connecting portion 121 can include an outer surface 1210 in tight contact with the inner surface 1120 of the second connecting portion 112 of the terminal movable member 11.

A first end portion of the shoulder 122 can be connected to the cylinder portion 123, and a second end portion of the shoulder 122 can be connected to the third connecting portion 121. The shoulder 122can be substantially a hollow disk. A maximum diameter of the shoulder 122 can be larger than the maximum diameter of the third connecting portion 121 and a maximum diameter of the cylinder portion 123, and a thickness of the shoulder 122 can be smaller than a thickness of the third connecting portion 121 and a thickness of the cylinder portion 123. The cylinder portion 123 can be latched in the base 20. In the embodiment, an outer surface of the cylinder portion 123 can include screw threads engaged with the base 20 to enhance a connecting strength of the lamp pole 10 to the base 20.

In at least one embodiment, the plug 12 can be hollow. In other embodiments, the plug 12 can be solid.

In at least one embodiment, the lamp pole 10 is not limited for use in the LED lamp 100.

The base 20 can include an assembly surface 21 facing the lamp pole 10. The assembly surface 21 can define a cylindrical assembly hole 22. A diameter of the assembly hole 22 can be smaller than the maximum diameter of the shoulder 122. The base 20 can include a power switch 23 on a side surface thereof. In at least one embodiment, the cylinder portion 123 of the plug 12 can be received in the assembly hole 22, and the shoulder 122 is mounted on the assembly surface 21.

In at least one embodiments, the plug 12 can be omitted, such that one end portion of the lamp pole 10 can be directly mounted in the base 20. For example, the terminal movable member 11 can be latched to the base 20 by screws.

In assembly, the plurality of movable members 11 are connected one-by-one. Then, the plug 12 can be connected to the terminal movable member 11, thereby assembling the lamp pole 10. The cylinder portion 123 of the plug 12 can be screwed into the assembly hole 22 of the base 20, such that the shoulder 122 can be mounted on the assembly surface 21 of the base 20. Finally, the lamp head 30 can be mounted to the lamp pole 10, thus completing assembly of the LED lamp 100.

As the lamp pole 10 can be bent freely, the height, bending angle, and bending direction of the lamp pole 10 can be adjusted easily. Therefore, the illumination range of the LED lamp 100 can be adjusted more conveniently and quickly.

It is believed that the present embodiments and their advantages will be understood from the foregoing description, and it will be apparent that various changes can be made thereto without departing from the scope of the embodiments or the following claims.

What is claimed is:

1. A lamp pole for supporting a lamp head, comprising:
a plurality of movable members connected one-by-one, wherein each of the plurality of the movable members comprises a first connecting portion and a second connecting portion connected to the first connecting portion; and wherein the first connecting portion and the second connecting portion are bowl-shaped, the first connecting portion of each movable member is connected to the second connecting portion of an adjacent movable member by being rotatably received in the adjacent second connecting portion.

2. The lamp pole as claimed in claim 1, wherein the first connecting portion comprises an outer surface, the second connecting portion comprises an inner surface, and the outer surface of the first connecting portion of the movable member is in contact with the inner surface of the second connecting portion of the adjacent movable member.

3. The lamp pole as claimed in claim 2, wherein the maximum diameter of the first connecting portion is slightly larger than the maximum diameter of the inner space of the second connecting portion.

4. The lamp pole as claimed in claim 2, wherein a distal end portion of the second connecting portion of each movable member includes a flange on the inner surface.

5. The lamp pole as claimed in claim 2, wherein the lamp pole further comprises a plug connected to a terminal movable member at one end of the lamp pole; the plug comprises a third connecting portion, a shoulder, and a cylinder portion connected in sequence.

6. The lamp pole as claimed in claim 5, wherein the third connecting portion comprises an outer surface in contact with the inner surface of the second connecting portion of the terminal movable member, and the third connecting portion is roratably received in the second connecting portion of the terminal movable member.

7. A LED lamp comprising
a lamp head;
a base; and
a lamp pole, wherein the lamp pole comprises a plurality of movable members connected one-by-one, and each of the plurality of the movable members comprises a first connecting portion and a second connecting portion connected to the first connecting portion; the first connecting portion and the second connecting portion are bowl-shaped, the first connecting portion of each movable member is connected to the second connecting portion of the adjacent movable member by rotatably received in the adjacent second connecting portion.

8. The LED lamp as claimed in claim 7, wherein the first connecting portion comprises an outer surface, the second connecting portion comprises an inner surface, and the outer surface of the first connecting portion of the movable member is in contact with the inner surface of the second connecting portion of the adjacent movable member.

9. The LED lamp as claimed in claim 8, wherein the maximum diameter of the first connecting portion is slightly larger than the maximum diameter of the inner space of the second connecting portion.

10. The LED lamp as claimed in claim 8, wherein a distal end portion of the second connecting portion of each movable member includes a flange on the inner surface.

11. The LED lamp as claimed in claim 7, wherein the lamp pole further comprises a plug connected to a terminal movable member at one end of the lamp pole; the plug comprises a third connecting portion, a shoulder, and a cylinder portion connected in sequence, and the third connecting portion is rotatably received in the second connecting portion of the terminal movable member.

12. The LED lamp as claimed in claim 11, wherein the plug is screwed in the base.

13. The LED lamp as claimed in claim 11, wherein the lamp pole is latched in the base.
